(19) United States
(12) Patent Application Publication
(10) Pub. No.: US 2006/0000677 A1
(43) Pub. Date: Jan. 5, 2006

(54) Energy generating mechanism

(76) Inventor: Chih-Ho Chiu, Sansia Township (TW)

Correspondence Address: TROXELL LAW OFFICE PLLC, SUITE 1404, 5205 LEESBURG PIKE, FALLS CHURCH, VA, 22041, US

(21) Appl. No.: 11/117,361

(22) Filed: Apr. 29, 2005

(30) Foreign Application Priority Data
Jun. 28, 2004 (TW) 93210124

(51) Int. Cl. F03G 3/00

(52) U.S. Cl. 185/27

(57) ABSTRACT

An energy generating mechanism includes an energy producing device and an energy collection device for collecting energy produced from the energy producing device. The energy producing device includes a truss, a first link and a second link which is pivotably perpendicularly connected to the first link on the truss. Each of the first link and the second link has two boxes on two ends thereof and each box has blocks movably received therein. The first and second links rotate continuously by changing the positions of the blocks so as

[symbol]

### FIELD OF THE INVENTION

The present invention relates to an energy generating mechanism which generates energy by rotating two links continuously and the energy is collected by an energy collection device.

### BACKGROUND OF THE INVENTION

Human consumes energy in a mass scale and the remained energy source on earth reaches a critical point which substantially threatens the living of human beings. Although wind power, solar power, hydro power and even the earth heat are developed to generate energy, the geographic conditions limits the use of the energy. It is a beginning stage for using the nature power and we have a long way to run before the nature power can be dominated by human beings.

The present invention intends to provide an energy generating mechanism that includes two perpendicular links and two boxes are located on two ends of each links and each box includes blocks movably therein so that the links be continuously rotate by changing the positions of the blocks. The rotation of the links generates energy which is collected by an energy collection device.

### SUMMARY OF THE INVENTION

The present invention relates to an energy generating mechanism which comprises an energy producing device and an energy collection device. The energy producing device has a truss on which a first link and a second link are pivotably and perpendicularly connected thereon. Each of the first link and the second link has two boxes on two ends thereof so as to balance the first and second links. Each box has blocks movably received therein.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the energy generating mechanism which is not yet activated;

FIG. 2 is a perspective view from another angle of the energy generating mechanism which is not yet activated;

FIG. 3 is a side view to show the energy generating mechanism which is not yet activated;

FIG. 4 is a partly side view of the energy generating mechanism;

FIG. 5 shows the blocks in boxes when the energy generating mechanism is not yet activated, and

FIGS. 6-11 show the movement of the first and second links when the blocks are moved in the boxes.

### DETAILED DESCRIPTION OF THE PREFERRED EMBODIMENT

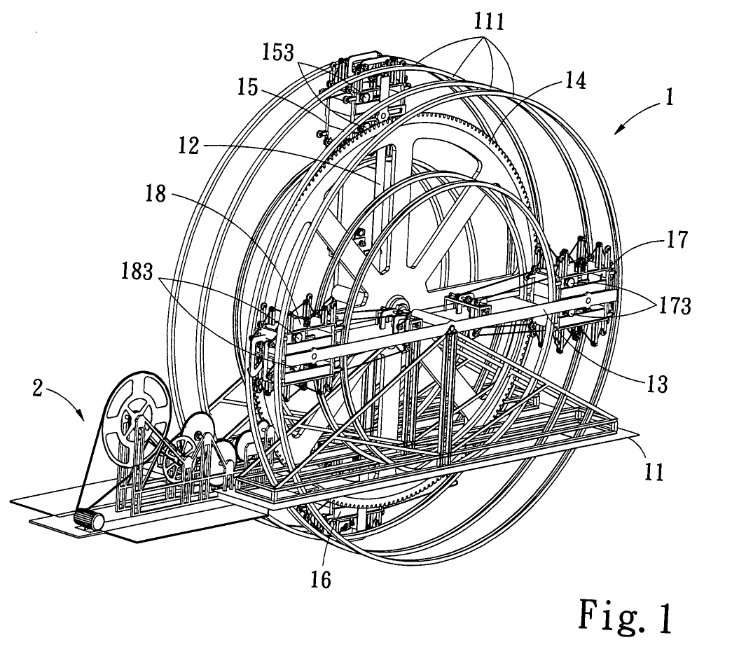

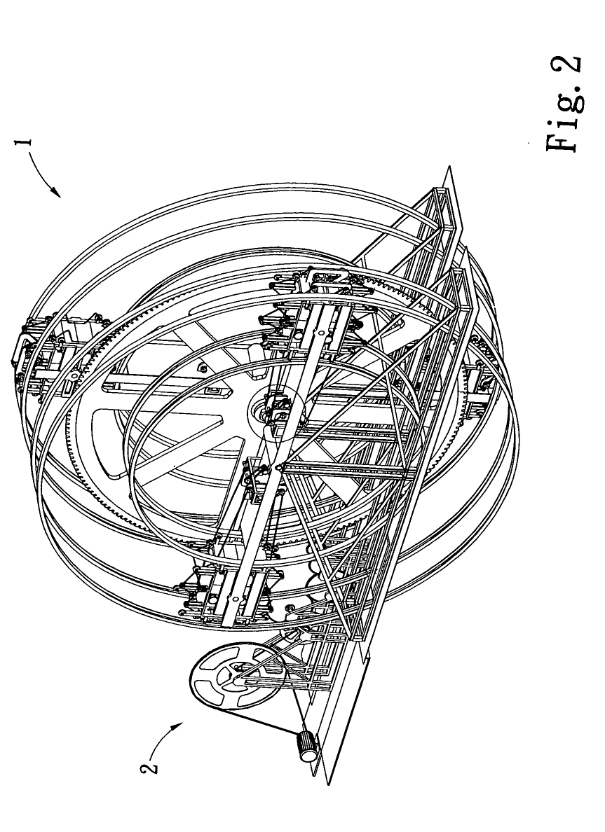

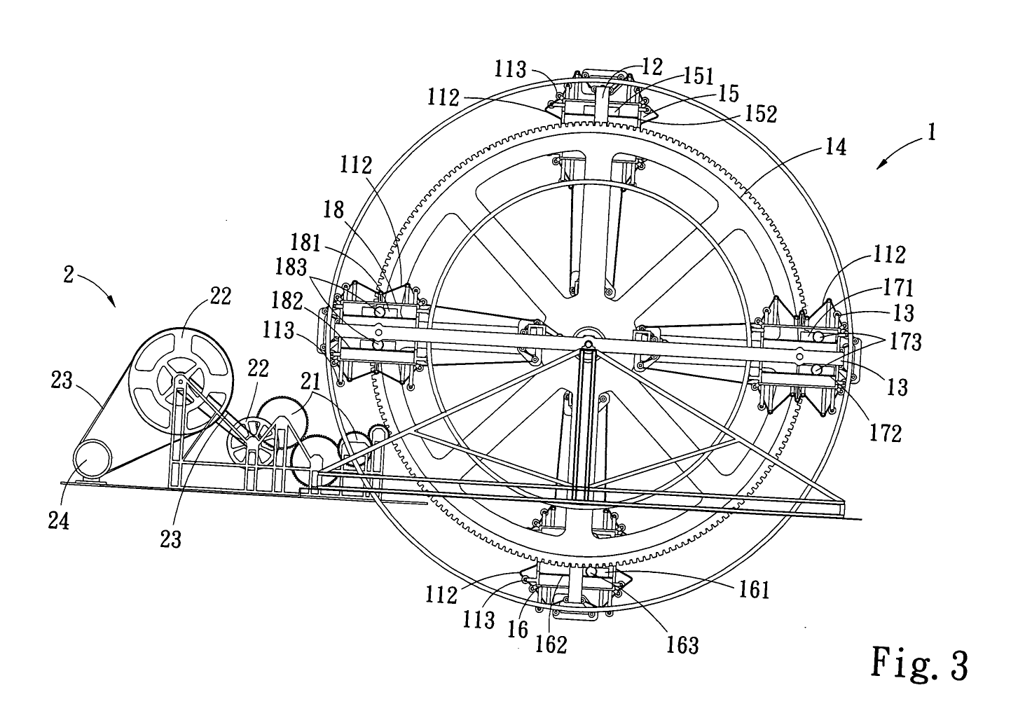

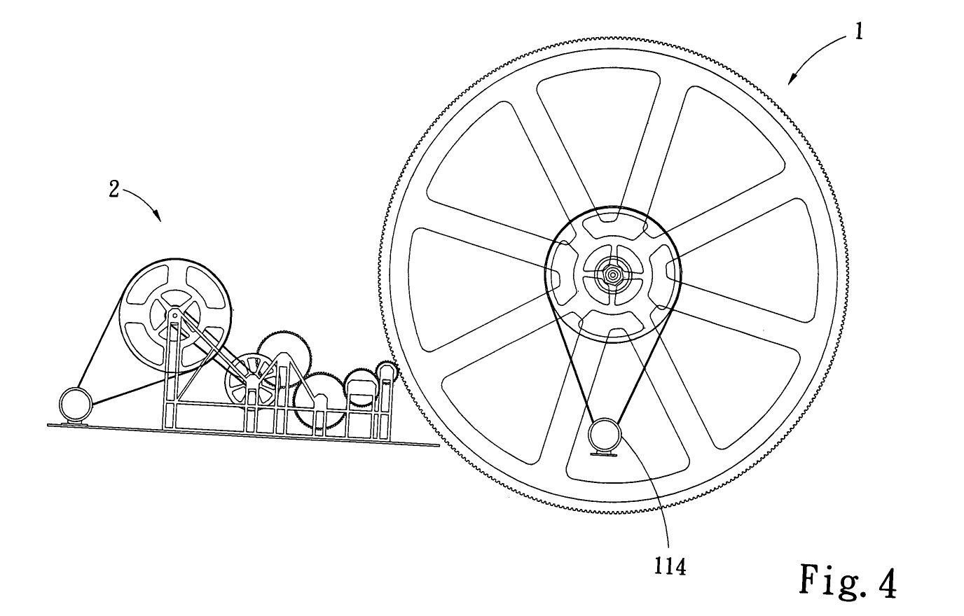

Referring to FIGS. 1 to 4, the energy generating mechanism of the present invention comprises an energy producing device 1 and an energy collection device 2 which includes a plurality of gears 21, wheels 22, belts 23 and an energy collection member 24 so as to collect the energy produced by the energy producing device 1.

The energy producing device 1 includes a truss 11, a first link 12 and a second link 13 are pivotably and perpendicularly connected with each other and are connected thereon to the truss 11. 2. A main gear 14 is co-axially connected to a pivotable axis of the first and second links 12, 13 and operationally connected to the energy collection device 2. Each of the first link 12 and the second link 13 has two boxes 15, 16 and 17,18 respectively on two ends thereof so as to balance the first and second links 12, 13. Each box 15,16,17,18 has blocks 151,161,171,181 movably received therein and rails 152, 162, 172, 182. Each box 15,16,17,18 further includes a driving motor 153,163,173,183 therein. The driving motor 153,163,173,183 moves the blocks 151,161,171,181 along the rails 152,162,172,182 and the driving motor 153,163,173,183 stops when the blocks 151,161,171,181 move to a desired position.

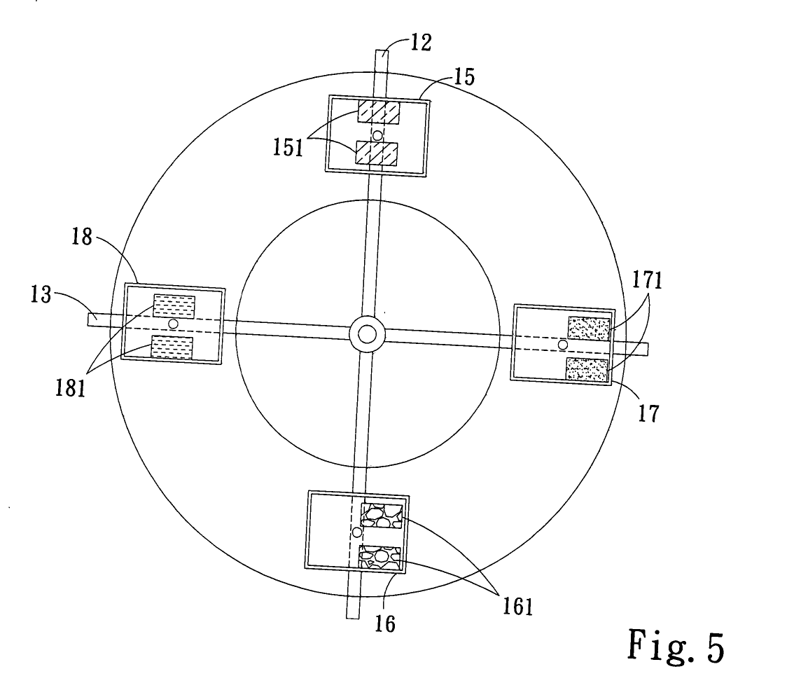

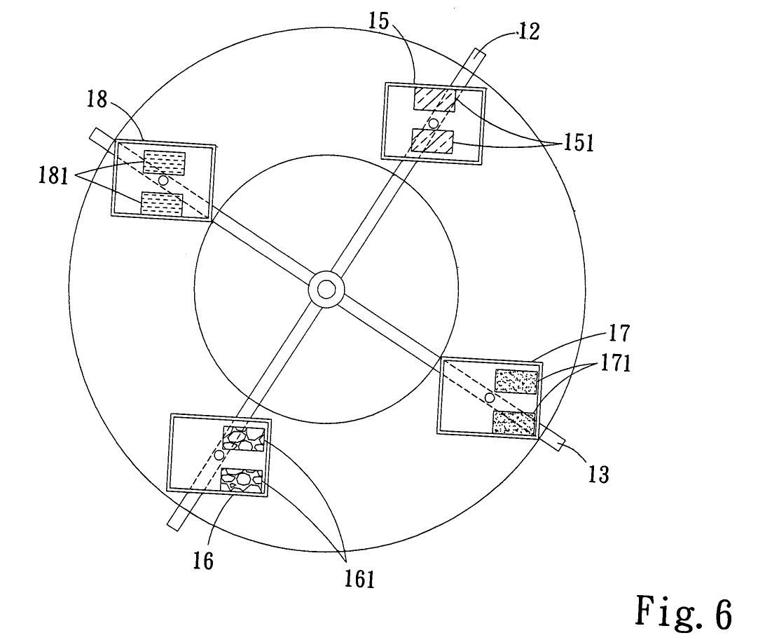

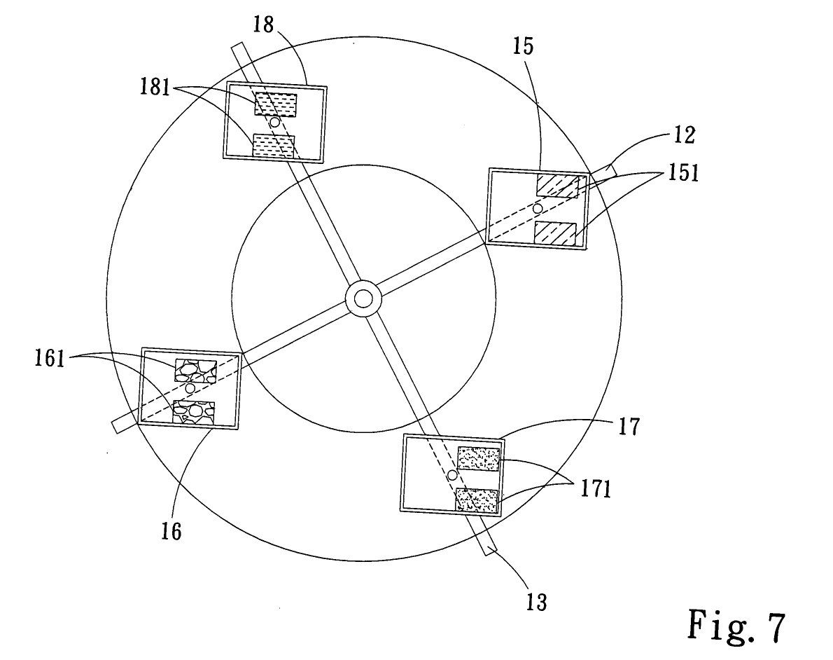

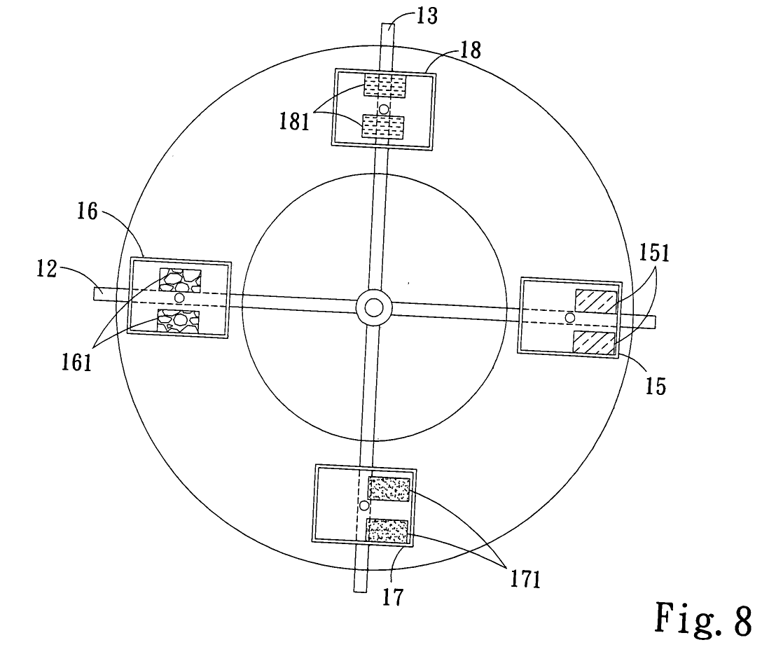

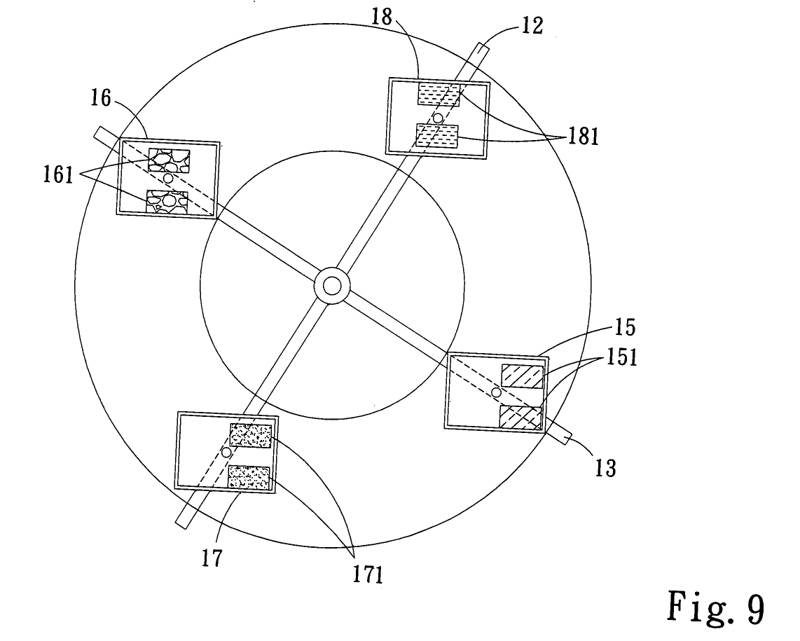

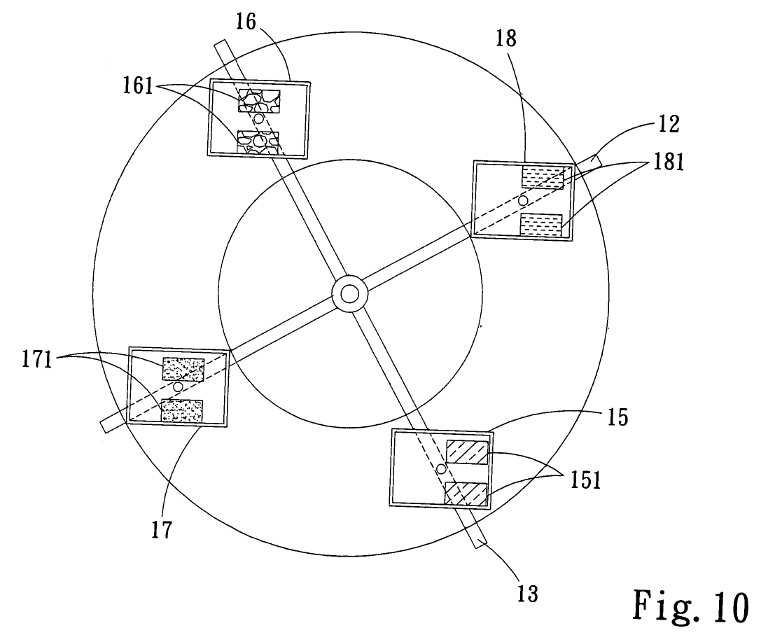

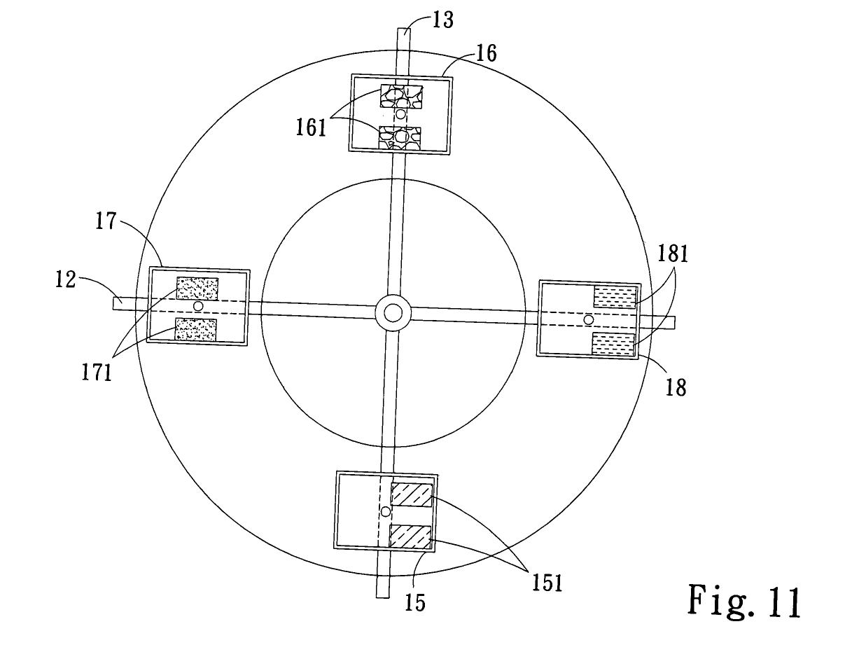

As shown in FIG. 5, the first link 12 is orientated vertically and the second link 13 is orientated horizontally before the mechanism is activated. Further referring to FIGS. 6-11, the blocks 151 in the box 15 on a top of the first link 12 are located at a center of the box 15, and the blocks 161 in the box 16 on a lower end of the first link 12 are located at right side of the box 16. The blocks 171 in the box 17 on right end of the second link 13 are located at right side of the box 17, and the blocks 181 in the box 18 on left side of the second link 13 are located at a center of the box 18. When the mechanism is activated, the blocks 151 in the box 15 move toward right of the box 15 and the blocks 161 in the box 16 move to a center of the box 16. By this way, the first and second links 12, 13 rotate clockwise and the main gear 14 is rotated to generate energy.

It is noted that two circular rails 111 are connected to two sides of the truss 11 and the boxes 15, 16, 17, 18 are connected to the truss 11 by adjustable cables 112 and pulleys 113. The pulleys 113 are connected to the circular rails 111. The boxes 15, 16, 17, 18 are moved along the circular rails 111 when the first and second links 12, 13 are rotated. The boxes 15, 16, 17, 18 are maintained in horizontal position on the circular rails 111 by the pulleys 113. A plurality of micro-adjustable motors 114 are connected between the truss 11 and the boxes 15, 16, 17, 18 so as to keep the boxes 15, 16, 17, 18 horizontally.

When the blocks 151, 161 in the boxes 15, 16 on the first link 12, or the blocks 171, 181 in the boxes 17, 18 of the second link 13 moved in opposite directions, the first link 12 or the second link 13 rotates and the other link is co-rotated. Therefore, the first and second links 12, 13 rotate continuously by the movement of the blocks 151, 161, 171, 181 and the main gear 14 transfers the energy produced by the rotation of the first and second links 12, 13 to the energy collection device 2. The energy is then collected via the gears 21, the wheels 22 and the belts 23.

The boxes 15, 16, 17, 18 are kept in horizontal positions by the micro-adjustable motors 114 so that a small movement of the boxes 15, 16, 17, 18 can make the first and second links 12, 13 rotate. Therefore, the energy producing device 1 effectively produces energy by a small amount of input energy.

While we have shown and described the embodiment in accordance with the present invention, it should be clear to those skilled in the art that further embodiments may be made without departing from the scope of the present invention.

What is claimed is:

1. An energy generating mechanism comprising:
an energy producing device (1) and an energy collection device (2), the energy producing device (1) having a truss (11), a first link (12) and a second link (13) pivotably perpendicularly connected with each other and connected to the truss (11), each of the first link (12) and the second link (13) having two boxes (15, 16,17, 18) on two ends thereof so as to balance the first and second links (12, 13), each box (15,16,17,18) having blocks (151,161,171,181) movably received therein.

2. The mechanism as claimed in claim 1, wherein a main gear (14) is co-axially connected to a pivotable axis of the first and second links (12, 13) and operationally connected to the energy collection device (2).

3. The mechanism as claimed in claim 1, wherein each box (15, 16, 17, 18) includes a driving motor (153,163,173,183) and a rail (152), the driving motor (153,163,173,183) moves the blocks (151,161,171,181) along the rail (153,163,173,183), the driving motor (153,163,173,183) stops when the blocks (151,161,171,181) move to a desired position.

4. The mechanism as claimed in claim 1, wherein the first link (12) is orientated vertically and the second link (13) is orientated horizontally before the mechanism is activated, the blocks (151) in the box (15) on a top of the first link (12) are located at a center of the box (15), the blocks (161) in the box (16) on a lower end of the first link (12) are located at right side of the box (15), the blocks (171) in the box (17) on right end of the second link (13) are located at right side of the box (17), the blocks (181) in the box (18) on left side of the second link (13) are located at a center of the box (18), when the mechanism is activated, the blocks (151) in the box (15) move toward right of the box (15) and the blocks (161) in the box (16) move to a center of the box (16), the first and second links (12, 13) rotate clockwise.

5. The mechanism as claimed in claim 1, wherein two circular rails (111) connected to two sides of the truss (11), the boxes (15, 16, 17, 18) are connected to the truss (11) by adjustable cables (12) and pulleys (113), the pulleys (113) are connected to the circular rails (111), the boxes (15, 16, 17, 18) are moved along the circular rails (11) when the first and second links (12, 13) are rotated, the boxes (15, 16, 17, 18) are maintained in horizontal position on the circular rails (111) by the pulleys (113).

6. The mechanism as claimed in claim 1, wherein the energy collection device (2) includes a plurality of gears (21), wheels (22), belts (23) and an energy collection member (24).

7. The mechanism as claimed in claim 1, wherein a plurality of micro-adjustable motors (114) are connected between the truss (11) and the boxes (15, 16, 17, 18) so as to keep the boxes (15, 16, 17, 18) horizontally.
